(19) United States
(12) Patent Application Publication
(10) Pub. No.: US 2006/0241788 A1
(43) Pub. Date: Oct. 26, 2006

(54) System and method for providing a combined bioprosthetic specification of goal state and path of states to goal

(76) Inventors: Lakshminarayan Srinivasan, Ellicott City, MD (US); Uri Tzvi Eden, Somerville, MA (US); Emery Neal Brown, Brookline, MA (US); Alan Steven Willsky, Bedford, MA (US)

Correspondence Address: DORSEY & WHITNEY LLP;INTELLECTUAL PROPERTY DEPARTMENT, 250 PARK AVENUE, NEW YORK, NY, 10177, US

(21) Appl. No.: 11/341,118

(22) Filed: Jan. 26, 2006

Related U.S. Application Data
(60) Provisional application No. 60/647,590, filed on Jan. 26, 2005.

(51) Int. Cl. G05B 19/18

(52) U.S. Cl. 700/56; 700/83

(57) ABSTRACT

The exemplary embodiments of the method, system and arrangement according to the present invention enables an estimation of reaching movements. For example, using the exemplary embodiments of the present invention, it is possible to derive a Bayesian-optimal discrete time state equation to support real-time filters that incorporate observations about the target position and arm trajectory. The exemplary embodiments of the present invention may be compatible with any filtering method, such as point process or Kalman filters, and any recording methods, such as multielectrode arrays, intracortical EEG, or eye trackers.

### CROSS-REFERENCE TO RELATED APPLICATIONS

This application claims priority from U.S. Patent Application No. 60/647,590, filed Jan. 26, 2005, the entire disclosure of which is incorporated herein by reference.

### GOVERNMENTAL SUPPORT

The research leading to the present invention was supported, at least in part, by National Institute of General Medical Sciences, “Medical Scientists Training Program”, Grant number 5T32GM07753-26 and National Institute on Drug Abuse, “Dynamic Signal Processing Analysis of Neural Plasticity”, Grant number R01 DA015644. Thus, the U.S. government may have certain rights in the invention.

### FIELD OF THE INVENTION

The present invention relates to a device and method which is configured to allow a user to specify goal and path of states to that goal in a consistent manner via biological signals such as those derived from brain or eye-tracker recordings. One exemplary application of the present invention is for a treatment and rehabilitation of patients with impairment of motor function.

### BACKGROUND INFORMATION

Machines that enable the user to express intended control signals can be broadly referred to as bio-prosthetics. There has been interest in developing bio-prostheses that can circumvent user's inability to reliably activate specific nerves or muscles, such as for patients with spinal cord lesions, stroke, tremor, or myopathies. Indeed, reaching movements to a ball with a robot arm or active brace device, or moving an on-screen mouse to an icon, are some examples for which the user expresses control signals through a bio-prosthetic that specify a goal and a trajectory of states of the prosthetic to achieve that goal.

A control bio-prosthetic generally can involve the mapping of user-derived signals, from brain, eye, muscle, or otherwise, onto control signals that specify aspects of the target state and the path to that target state. One of the problems addressed by the exemplary embodiments of the present invention is the problem of combining user-derived signals relating to target as well as path into one consistent set of control signals that can be used in real-time for moving the bio-prosthetic from the current state, through the desired path, to the desired target.

Currently available real-time methods either allow the user to specify the path to the goal (as described in Wu, W. et al., “Modeling and decoding motor cortical activity using a switching Kalman filter,” IEEE Trans. On Biomedical Engineering 51 (6), pp. 933-942 Jun. 2004), or the goal itself (as described in Musallam, S., et al., “Cognitive Control Signals for Neural Prosthetics.” Science, 305(5681), pp. 258-262). The result in the first case is that the path is unconstrained by the goal, and in the second case is that there is no real-time user-controlled ability to specify the path to the goal.

One conventional method described in C. Kemere, et al. “Model-based neural decoding of reaching movements: a maximum likelihood approach,” IEEE Trans. On Biomedical Engineering, Jun. 2004, pp. 925-932, and C. Kemere et al., “Model-Based Decoding of Reaching Movements for Prosthetic Systems,” Proc. Of the 26^{th} th Annual Conf. Of the IEEE EMBS, Sep. 2004, pp. 4524-4528, in the specific context of decoding reaching arm movements, attempted to combine hand target and current kinematic information from motor cortical-derived signals in order to estimate trajectory states. However, this method uses a predefined template trajectory distribution or a discrete database of arm movements to be pre-recorded for each potential target location. The brain activity is matched to one of these template arm motions to select a target and the current arm position according to the best template arm movement. Moreover, this method uses batch-mode processing of all data, and may require a numerical maximization procedure.

In contrast, the free arm movement estimation literature has largely relied on either no models or random walk-type models, both for computational simplicity and for robustness in the face of uncertain movement constraints as described in A.B. Schwartz, “Cortical Neural Prosthetics”, Annu. Rev. Neurosci., vol. 27, pp. 487-507, Mar. 2004.

### OBJECTS AND SUMMARY OF EXEMPLARY EMBODIMENTS OF THE INVENTION

Certain exemplary embodiments of the present invention provide a system, method, an executable arrangement, and computer-accessible medium for providing state information relating to a simulated or actual execution of one or more trajectories of an object. A first set of data can be obtained prior to execution of a trajectory, which can include information relating to a portion of the trajectory including, e.g., an estimation of a particular state of the trajectory at a later point in time. A second set of data can then be obtained during execution of the trajectory, which can include information relating to a portion of the trajectory, e.g., the time at which the object reaches one particular state of the trajectory. State information may then be generated by associating the first and second data sets, independently of data associated with predetermined trajectories. The state information may be generated in real time and/or in a recursive manner, and may optionally be used to affect the execution of the object trajectory. The data sets may be associated with signals obtained from one or more anatomical structures, such as a brain, an eye, a muscle, a tongue, and the like.

In further exemplary embodiments of the present invention, the first and/or second data set may exclude a predetermined arrival time for a particular state.

In further exemplary embodiments of the present invention, a third data set associated with a minimal probabilistic constraint on the trajectory and the current position of the object may also be used in generating the state information relating to the trajectory.

According to exemplary embodiments of the present invention, a generic model of free arm movement can be combined with information about the target state to produce a generic model for reaching arm movement. Uncorrelated increments may also facilitate the use with real-time recursive estimation procedures, such as Kalman filters.

The exemplary embodiments according to the present invention can utilize such models, which may represent a set of prior states for any method of estimating arm movements, including point process filters, Kalman filter variants, particle filters, or general probabilistic inference. Measurements from any device or brain region can be incorporated into this estimation procedure, including local field potentials and spiking activity.

According to one exemplary embodiment of the present invention, continuous time surveillance methods as described in D.A. Castanon et al. ¢Algorithms for the incorporation of predictive information in surveillance theory”, Int. J Systems Sci., vol. 16, no. 3, pp. 367-382, 1985 can be adapted for discrete time. The exemplary derivations described herein follow an approach similar to a discrete-time backwards Markov model construction as provided in G. Verghese et al., “A Further Note on Backwards Markovian Models”, IEEE Trans. Info. Theory, vol. IT-25, no. 1, Jan. 1979.

Further, a goal-directed reach state equation can be utilized by the exemplary embodiments of the present invention. In addition, an augmented state space may be used to accommodate concurrent target dynamics. These exemplary methods (and systems implementing such methods) can be used to estimate arm movement from simulated cortical activity during a reach.

For example, exemplary embodiments of the method, system, executable arrangement, and computer-accessible medium according to the present invention can provide for a maximum flexibility in allowing the user to specify a target and a continuous path to that target. Such exemplary embodiments may be compatible with real-time processing of signals. In contrast to the exemplary embodiments of the present invention, some conventional methods and devices require the use of previously provided and static trajectory specifying information. In addition, a number of conventional methods and devices require the use of a pre-recorded database of movements, a control signal of specific dimension, or probabilistic template matching to a discrete database of pre-recorded arm movements.

For example, the exemplary embodiments of the present invention can be compatible with real-time signal processing methods. For example, according to one exemplary embodiment of the present invention, and in contrast with conventional techniques, batch processing is not necessary and control signals can be updated efficiently with the last observation of the biological signals. In addition, according to another exemplary embodiment of the present invention, a number of calculations are precomputed, again facilitating real-time application. Further, according to another exemplary embodiment of the present invention, no numerical optimization is needed and the optimal solution can be analytically expressed. Indeed, these benefits represent improvements, and can facilitate a facile production of goal-directed control signals.

For example, the exemplary embodiments of the present invention can facilitate any interface between a person and a machine where the person can describe to the machine an intended target position and path to the target with any level of certainty. One exemplary application of such exemplary embodiment can be a bio-prosthetic application, where brain or eye-tracker derived signals are used to communicate a user's intent in controlling a machine. Further, patients with sensorimotor deficits (including central and peripheral neuropathies, as well as muscle disorders) may benefit from the bio-prosthetics that allow them to express control signals without the direct activation of affected muscles or nerves. Goal directed movements may be common to our everyday function. The exemplary embodiments of the present invention can provide a flexible, real-time solution to facilitating such classes of movements, and can seamlessly integrates with the expression of continuous movements.

These and other objects, features and advantages of the present invention will become apparent upon reading the following detailed description of embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a general computational flowchart for certain exemplary embodiments of the present invention;

FIG. 2A is an exemplary graph of a reconstruction of reaching arm movements from simulated spiking activity, with an x-y position reconstruction being plotted for one trial with a known target;

FIG. 2B is an exemplary graph of the reconstruction of the reaching arm movements from simulated spiking activity corresponding to FIG. 2A, with the x position is plotted against time;

FIG. 2C is an exemplary graph of the reconstruction of the reaching arm movements from simulated the spiking activity corresponding to FIG. 2A, with the y position is plotted against time;

FIG. 3A is an exemplary graph of the reconstruction of the reaching arm movements from the simulated spiking activity of FIG. 2A, with a velocity reconstruction being plotted for one trial with the known target;

FIG. 3B is an exemplary graph of the reconstruction of the reaching arm movements from the simulated spiking activity of FIG. 2A, with the x velocity reconstruction being plotted against time;

FIG. 3C is an exemplary graph of the reconstruction of reaching the arm movements from the simulated spiking activity of FIG. 2A, with the y velocity reconstruction being plotted against time;

FIG. 4A is an exemplary graph of the position reconstruction due to a model violation;

FIG. 4B is the position reconstruction of FIG. 4A, with the x position plotted against time;

FIG. 4C is the position reconstruction of FIG. 4A, with the y position plotted against time;

FIG. 5A is an exemplary graph of the velocity reconstruction corresponding to the position reconstruction of FIG. 4A due to the model violation;

FIG. 5B is the position reconstruction of FIG. 5A, with the x velocity plotted against time;

FIG. 5C is the position reconstruction of FIG. 5A, with the y velocity plotted against time;

FIG. 6 is a graph of variances in estimates of target (black line) and path (gray line) plotted on a logarithmic scale over a duration of one reach for position (solid line) and velocity (dashed line);

FIG. 7A is a graph of a target estimation for one exemplary trial where a true target location was initially set incorrectly at, and subsequent target estimates are produced using a simulated neural spiking activity;

FIG. 7B is a plot of target estimation for the trial provided in FIG. 7A, where distances from the target estimates to the actual target location are plotted as a function of time;

FIG. 8 is a graph of a mean squared error in position for a reach model approaches that of the free movement model as uncertainty in the target position increases; and

FIG. 9 is a schematic system diagram of an exemplary embodiment of the present invention.

### DETAILED DESCRIPTION OF EXEMPLARY EMBODIMENTS OF THE INVENTION

The exemplary embodiments of the device and system according to the present invention can be implemented using the following exemplary techniques.

I. Incorporation of Target Information

Initially, any P-dimensional linear time-varying discrete-time state space model of free arm movement can be provided. At time t, the vector xₜ describes the arm state, Aₜ is an invertible state transition matrix, and wₜ may be a zero mean Gaussian increment:
xₜ=Aₜxₜ₋₁+wₜ (1)
E[wₜw′_{T}]=Qₜδ_{t-T} (2)

The initial condition can be specified as
x₀˜N(m₀,π₀) (3)

An observation of target position specified with uncertainty for known arrival time T can be written as follows:
y_{T}=x_{T}+v_{T} (4)
where vₜ˜N(0,π_{T}) denotes the observation noise. The Bayes least squares estimate of each increment wₜ conditional on the noisy observation Y_{T} of the target location and the present location xₜ₋₁ are to be obtained. This can be equivalent to the linear least squares estimate (“LLSE”) for jointly Gaussian distributions. The standard LLSE estimate of wₜ from Y_{T} can be provided as follows:
\hat{w}ₜ(y_{T})=E[wₜ]+cov(w_{t,}y_{T})cov⁻¹(y_{T,}y_{T})(y_{T}−E[y_{T}]) (5)

The further increment can correspond to an error of the LLSE estimate, with covariance given by:
cov(eₜ)=cov(wₜ)−cov(w_{t,}y_{T})cov⁻¹(y_{T})cov′(w_{t,}y_{T}) (6)

The expected value of wₜ may be zero. To derive expressions for the expected value and covariances involving y_{T}, y_{T} is provided in terms of xₜ₋₁,V_{T} and the intervening increments wᵢ for t≦i≦T; that is

$${y}_{T} = ϕ ( T , t - 1 ) {x}_{t - 1} + {\sum }_{i = t}^{T} ϕ ( T , i ) {w}_{i} + {υ}_{T} \qquad ( 7 )$$

where ∅(t, s) denotes the state transition matrix that maps the state xₛ to the state xₜ,

$$ϕ ( t , s ) = \{ \begin{matrix}{\prod }_{i = 1 + min ( t , s )}^{max ( t , s )} {A}_{i}^{sign ( t - s )} , t \neq s \\ I , t = s\end{matrix} \qquad ( 8 )$$

It follows that the expected value of Y_{T} is
E[y_{T}]=φ(T,t−1)x(t−1) (8a)
with covariance terms

$$\begin{matrix}\begin{matrix}cov ( {y}_{t} , {y}_{t} ) = E [ \begin{matrix}( {y}_{i} - ϕ ( T , t - 1 ) x ( t - 1 ) ) \\ {( {y}_{i} - ϕ ( T , t - 1 ) x ( t - 1 ) )}^{T}\end{matrix} ] \\ = E [ {\sum }_{i = t}^{T} ϕ ( T , i ) w ( i ) {w}^{T} ( i ) {ϕ}^{T} ( T , i ) ] + E [ {υ}_{i} {υ}_{i}^{T} ] \\ = {\sum }_{i = t}^{T} ϕ ( T , i ) {Q}_{i} {ϕ}^{T} ( T , i ) + {Π}_{T}\end{matrix} & ( 8 b ) \\ and & \\ \begin{matrix}cov ( {w}_{t} , {y}_{t} ) = E [ ( {w}_{t} - 0 ) {( {y}_{t} - ϕ ( T , t - 1 ) x ( t - 1 ) )}^{T} ] \\ = E [ {{w}_{i} ( {\sum }_{i = t}^{T} ϕ ( T , i ) w ( i ) + {v}_{T} )}^{T} ] \\ = {Q}_{t} {ϕ}^{T} ( T , t )\end{matrix} & ( 8 c )\end{matrix}$$

It should be understood that in the formulas below, φ^{T} should be considered approximately or substantially the same as φ′. Then, the mean and covariances of Y_{T} are determined and substituted into the LLSE estimation formula (5) above to obtain the mean of the increment based on target information,

$$\begin{matrix}\begin{matrix}{\hat{w}}_{t} ( {y}_{T} ) = {Q}_{t} {ϕ}^{′} ( T , t ) \times \\ {[ {Π}_{T} + {\sum }_{i = t}^{T} ϕ ( T , i ) {Q}_{i} {ϕ}^{T} ( T , i ) ]}^{- 1} \times \\ [ {y}_{T} - ϕ ( T , t - 1 ) {x}_{t - 1} ]\end{matrix} & ( 9 ) \\ where & \\ {Π}_{T} = E [ {υ}_{T} {υ}_{T} ] & ( 10 )\end{matrix}$$

The error covariance can be derived from formula (6) above and simplified to obtain

$$\begin{matrix}cov ( {ε}_{t} ) = {Q}_{t} - {Q}_{t} {Π}^{- 1} ( t , T ) {Q}_{t}^{′} & ( 11 ) \\ where & \\ Π ( t , T ) = ϕ ( t , T ) {Π}_{T} {ϕ}^{′} ( t , T ) + {\sum }_{i = t}^{T} ϕ ( t , i ) {Q}_{i} {ϕ}^{′} ( t , i ) & ( 12 )\end{matrix}$$

Therefore, the increment wₜ together with a provided xₜ₋₁ and noisy target observation Y_{T} may have a mean \hat{w}ₜ and covariance cov(Cₜ) as determined above.

For example, the quantity Π(t, T) can be determined recursively starting at Π(T, T). To obtain this result, it is possible to compare the equations for Π(t−1, T) and Π(t, T ). The consequent recursion can be written as

$$\begin{matrix}\begin{matrix}Π ( t - 1 , T ) = ϕ ( t - 1 , t ) Π ( t , T ) {ϕ}^{′} ( t - 1 , t ) + \\ ϕ ( t - 1 , t ) {Q}_{t} {ϕ}^{′} ( t - 1 , t )\end{matrix} & ( 13 ) \\ with & \\ Π ( T , T ) = {Π}_{T} + {Q}_{T} & ( 14 )\end{matrix}$$

For an estimation, Π(t, T) can be determined with each new observation, intermittently, or not at all.

To complete the equivalent reach state equation, the initial state and covariance may be updated with standard LLSE formulas,
Π_{S}=(Π⁻¹₀+Π⁻¹(0,T))⁻¹ (15)
xₛ=Π_{S}(0)(Π⁻¹₀m₀+Π⁻¹(0,T)φ(0,T)y_{T}) (16)

In summary, the equivalent state equation for reaching movements may be provided by
xₜ=Aₜxₜ₋₁+uₜ+eₜ (17)
uₜ=\hat{w}ₜ(y_{T}) (18)
eₜ˜N(0,cov(eₜ)) (19)
x₀˜N(xₛ,Πₛ) (20)

The exemplary embodiment of the process resulting from the new state equation (17) may also be Markov, because xₜ is a function of the state at only the preceding time step xₜ₋₁ . Additionally, based on the orthogonality principle, the C, can be uncorrelated.

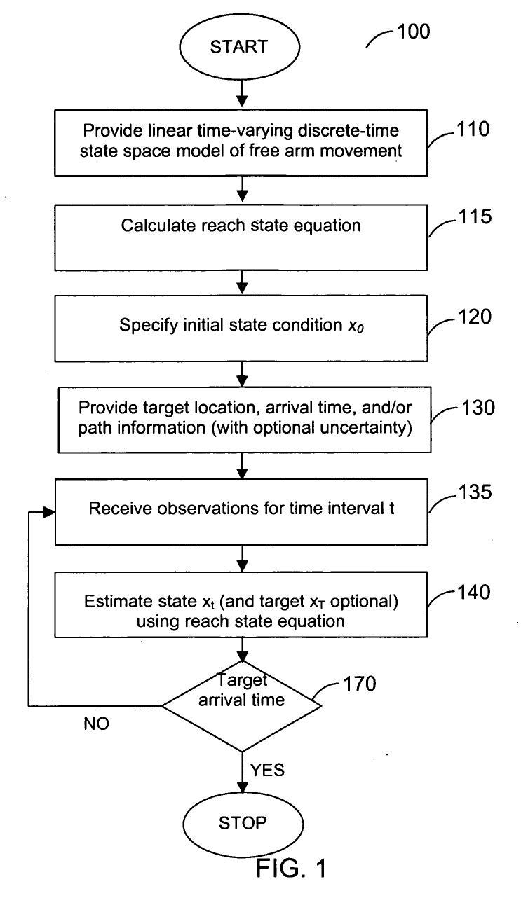

An exemplary flow diagram of the method 100 according to the present invention is shown in FIG. 1 which shows the steps that may be used to determine the successive reach states of a bio-prosthetic or similar device based on supplied target and/or path information, e.g., according to the above derivation. As an initial matter, a state space model describing movement of the arm or other bio-prosthetic device may be provided (step 110 ). This model may be predetermined, and it can include factors such as position and velocity of the arm segments, and joint torque. A reach state equation can be determined in step 115, the initial state condition can then be provided (step 120), as well as a target location and arrival time (step 130), each possibly including a degree of uncertainty. In step 135, observations for the time interval can be received. The new incremental change in state can then be calculated using the relationships in equations (17)-(20) described above together with any observation relationship (equation or probability density function) and estimation procedure. Optionally, observations of the target may be used to update uncertain or noisy target information during the reach, as described below. If the target arrival time is not yet reached (step 170 ), then a new state is estimated (step 140 ) using updated observations for time interval t, and the process can be repeated until the target is reached. A modification of this method which allows for uncertainty in target arrival times is also described herein.

The above equation (17) provides an intuition about the evolution of the arm trajectory under the exemplary reaching model according to the present invention. As the hand moves closer to the target in time, the trajectory can become more constrained by the target location. This can be accomplished by a combination of the forcing term u, and the noise term C,. With time, the forcing term more insistently pushes the arm to a path that sets it on course for the target. The covariance in the noise term can taper in proportion to target uncertainty as it becomes more apparent that specific changes in state are needed to bring the arm to the target at time T.

II. Uncertain Reach Duration

Typically, at times, it is may not be possible to confirm that an arm will meet the target at precisely time T. More realistically, it may be possible to specify a distribution of arrival times that are observed. It is possible to express an uncertainty in arrival time as a distribution p(T) on T. In this context, the results from the previous section for fixed arrival time can be interpreted as a state evolution equation conditioned on T. It is possible to employ Bayes rule to describe the distribution of increments that results from uncertain arrival time, as

$$p ( {w}_{t} \vert {x}_{t - 1} , {x}_{T} ) = \int p ( {w}_{t} \vert {x}_{t - 1} , {x}_{T} , T ) p ( T ) ⅆ T \qquad ( 20 a )$$

As described above, p(wt\xₜ₋₁, x_{T}, T)˜N(ŵₜ, cov(ŵₜ)). However, this distribution is not Gaussian in the T parameter. Consequently, even if the p(T) distribution was Gaussian, the resulting distribution p(wₜ\xₜ₋₁, x_{T}) would likely not be Gaussian. While non-Gaussian increments are generally incompatible with standard LLSE techniques, computational approaches are available to propagate non-Gaussian distributions through state equations, including particle filters, mixture of Gaussians, and numerical integration of the above Bayes rule formula.

In a numerical integration, a discrete set of M arrival times can be considered, and the increment estimates for each arrival time may be combined by weighting their respective probabilities,

$$p ( {w}_{t} \vert {x}_{t - 1} , {x}_{T} ) = {\sum }_{i = 1}^{M} p ( {w}_{t} \vert {x}_{t - 1} , {x}_{T} , T ) p ( {T}_{i} ) \qquad ( 20 b )$$

The resulting density may be approximated with a Gaussian density to allow compatibility with LLSE.

An alternative exemplary embodiment of the method according to the present invention can execute filters in parallel that assume different arrival times. The estimated state at each point may be an average of the individual filter predictions, weighted by the probability of the assumed target time. The actual target time probabilities can be adjusted based on the difference between the predicted and observed measurement, which may be referred to as an innovation in Kalman filters. The innovation for each filter can be obtained from a zero mean Gaussian with variance of the predicted observation, substantially equal in the Kalman filter to the state prediction variance sent through the observation equation.

With a data likelihood provided for each filter, the probability of each arrival time can be updated by Bayes rule, multiplying each data likelihood by the old probability of arrival time and normalizing. This exemplary update of probabilities may provide a dynamical estimate of target arrival time. Various forms of this exemplary method are described in the publications referenced herein.

III. Updating Target Estimate

Observations regarding the reach path can also be used to refine estimates of the target if path and target are dependent. To support a recursive estimation of target position, it is possible to augment the state space with X_{T} to include target position and target velocity variables. The resulting state equation can be provided as

$${[ \begin{matrix}x \\ {x}_{T}\end{matrix} ]}_{t} = {[ \begin{matrix}Ψ & Γ \\ 0 & I\end{matrix} ] [ \begin{matrix}x \\ {x}_{T}\end{matrix} ]}_{t - 1} + {E}_{t} \qquad ( 21 )$$

where
Ψ=Aₜ−Qₜφ′(t−1,t)Π⁻¹(t−1,T) (22)
T=Qₜφ′(t−1,t)Π⁻¹(t−1,T)φ(t−1,T) (23)
and the increment can be
Eₜ=[eₜ 0 ]′ (24)

Uncertainty can be added to this increment to track possible drifts in target states.

Such a one-state equation can support a real-time decoding of concurrent or sequential neural activity likely relating in various degrees to the path and target of the reach. When only trajectory information is available, the model can be reduced to a free-arm movement, where uₜ is zero and C, retains approximately the same statistics as wₜ. When only the target information is available, the model dynamics can travel to the target in proportion to the uncertainty about the target based on uₜ. Because the target position and velocity become state variables, refined estimates of the target can be available even as the reach proceeds.

IV. Exemplary Applications

To illustrate the flexibility of the above reach state equation, it is possible to simulated neural spiking data from primary motor cortex in response to a simulated two dimensional trajectory. A linear update point process filter based on the probabilistic principles of Kalman filters can be used to reconstruct the trajectory using a free arm movement state equation and the reach state equation. The point process filtering method has been described in detail in U.T. Eden, “Dynamic Analysis of Neural Encoding by Point Process Adaptive Filtering”, Neural Computation, vol. 16, no. 1, 2004. Another article, i.e., Alan S. Willsky, 6.433 Recursive Estimation: Supplementary Notes, MIT Course 6.433 Notes, Topic 5.4, p. 18, 1994, may also be relevant thereto.

The general point process observation equation for the i^{th} neuron at time t can be approximated as follows

$$Pr ( Δ {N}_{t}^{i} \vert {x}_{t} , {H}_{t}^{i} ) = exp [ Δ {N}_{t}^{i} log ( λ ( t \vert {x}_{t} , {H}_{t}^{i} ) δ ) - λ ( t \vert {x}_{t} , {H}_{t}^{i} δ ) ] \qquad ( 25 )$$

where Hⁱₜ denotes the history of state xₜ and spikes ΔNⁱₜ per time interval δ up to (but possibly excluding) timestep t. The conditional intensity function described and shown above can follow a primary motor neuron cosine tuning technique as described in D. Moran et al., “Motor cortical representation of speed and direction during reaching,” J Neurophys., vol. 82, no. 5, pp. 2676-2692, 1999, and as provided by the following formula:
λ(t\v_{x,}v_{y})=exp(β₁+β₂ vₓ+β₃v_{y}) (26)

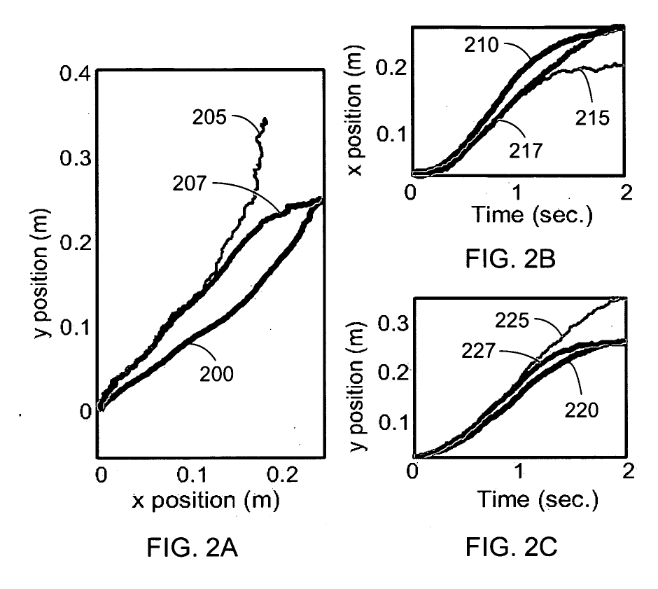

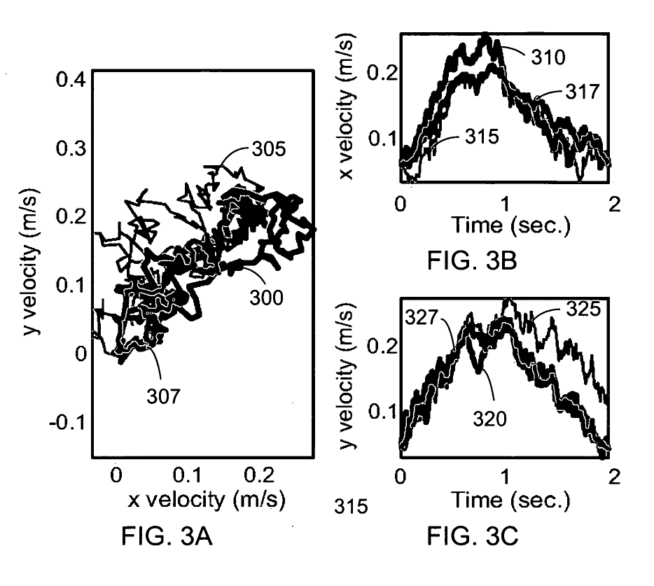

The performance in decoding reaching movements using the free arm movement model (a) can be compared against results using the reach state equation (17) provided herein. Exemplary results thereof are illustrated for one example in FIGS. 2A-2C and 3A-3C. While using the free movement model may allow for an estimation of trajectory, the use of the reach model with a certain knowledge of the target can provide that the estimated trajectory may converge to the target. Moreover, certain trajectory reconstructions may likely be improved over the entire duration of the reach.

In particular, FIGS. 2A-2C illustrate exemplary position decoding results for one simulated trial on a trajectory generated from the reach state equation. In this exemplary trial, the filter employing a reach state equation can be provided with the target location at a relative certainty. The x-y position 200 of the actual trajectory in FIG. 2A can be compared to the trajectory 205 obtained by using a free movement state equation and the trajectory 207 obtained using the reach state equation. The time dependence of the x position 210 shown in FIG. 2B, corresponding to the actual trajectory 200 in FIG. 2A, is compared to the x positions 215 and 217, e.g., obtained by using a free movement state equation and the reach state equation, respectively. Similarly, FIG. 2C shows a graph of the reconstruction to compare the time-dependent y position 220 of the actual trajectory to the y positions 225 and 227, obtained by using a free movement state equation and the reach state equation, respectively.

FIGS. 3A-3C illustrate graphs of arm velocity results corresponding to the position results shown in FIGS. 2A-2C. For example, the x-y velocities 300 of the actual trajectory shown in FIG. 3A are plotted with the velocities 305 obtained by using a free movement state equation, and the velocities 307 obtained using the reach state equation. The time dependence of the actual x velocity 310 shown in FIG. 3B, corresponding to the actual velocities 300 in FIG. 3A, may be compared to the time-dependent x velocities 315 and 317 that are obtained when using the free movement state equation and the reach state equation, respectively. FIG. 3C shows a graph of the reconstruction to compare the actual time-dependent y velocity 320 to the free movement state equation y velocity 325, and to the reach state equation y velocity 327.

The exemplary embodiment of the point process filter results may track the actual trajectory more closely with the reach state equation than with the free movement state equation. The reach state equation can be used to generate trajectories, from which a spiking activity may be simulated with a receptive field model of primary motor cortex. Point process filter reconstructions using a free movement state equation and a reach state equation can be compared against true movement values. In these examples shown in FIGS. 2A-2C and 3A-3C, the target location may be obtained to possibly match to the reconstruction that uses the reach state equation, with position and velocity variances of, e.g., 1e-5 m².

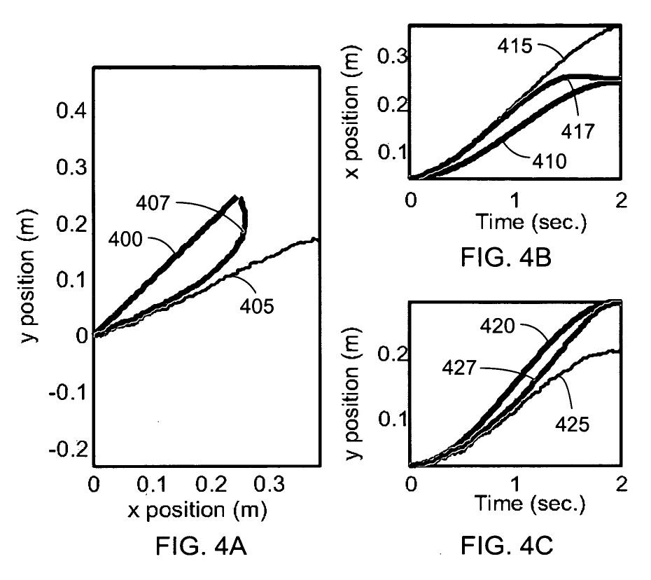

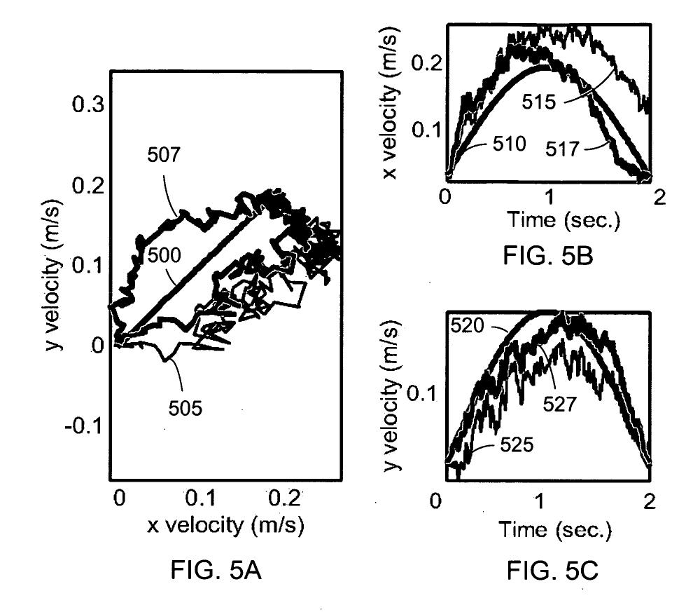

Decoding under a simple model violation can then be examined. For example, as shown in FIGS. 4A-4C and 5A-5C, a canonical scaled cosine velocity model can be employed to generate a sample reach trajectory. The movement can then again be reconstructed using a point process filter with free and reaching movement models. For example, in FIG. 4A, the x-y position 400 of the actual trajectory may be compared to the x-y position 405 obtained using a free movement state equation, and the x-y position 407 obtained using the reach state equation. The time dependence of the x position 410 shown in FIG. 4B, corresponding to the actual trajectory 400 shown in FIG. 4A, may be compared to the x positions 415 and 417, obtained by using the free movement state equation and the reach state equation, respectively. Similarly, FIG. 4C shows a graph of the reconstruction to compare the time-dependent y position 420 of the actual trajectory to the y positions 425 and 427, obtained using the free movement state equation and the reach state equation, respectively.

FIG. 5A illustrates exemplary arm velocity results obtained using the canonical scaled cosine velocity model used to produce the position results in FIGS. 4A-4C. The x-y velocities 500 of the actual trajectory shown in FIG. 5A are plotted with the velocities 505 obtained by using a free movement state equation, and the velocities 507 obtained using the reach state equation. The time dependence of the actual x velocity 510 shown in FIG. 5B, corresponding to the actual velocities 500 shown in FIG. 5A, is compared to the time-dependent x velocities 515 and 517 that result from using the free movement state equation and the reach state equation, respectively. FIG. 5C shows a graph of the reconstruction to compare the actual time-dependent y velocity 520 to the free movement state equation y velocity 525, and to the reach state equation y velocity 527.

FIGS. 4A-4C and 5A-5C demonstrate that, while both models tracked the reach when using a canonical scaled cosine velocity model, the reach movement model may track the reach more closely than the free reach model using such exemplary computations by incorporating target information.

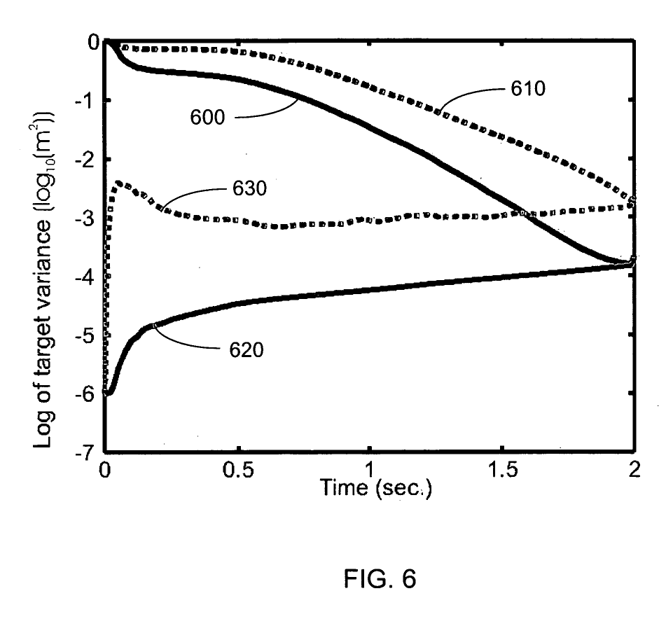

An exemplary refinement of target estimates from the trajectory related neural activity may then be illustrated. Because the target state augmented reach model of equation (21) can be employed, target estimates can be refined with each sample of neural data observed during the movement. Target estimation with the augmented state equation may be determined for one trial. The initial estimate of the target can be intentionally set to be incorrect at (1 m, 1 m) and with a variance of I m2 that is large relative to the distance to the true target location at (0.25 m, 0.25 m). Subsequent target estimates may be produced using a simulated neural spiking activity that can relate directly to the path rather than the target. FIG. 6 illustrates a graph of exemplary results showing the variance in estimates of target position 600 and target velocity 610, and of estimates of path position 620 and path velocity 630, which were each plotted as a function of time over the full course of a reach. These target estimate variances can be reduced with observations consisting of a simulated primary motor cortical activity relating to path.

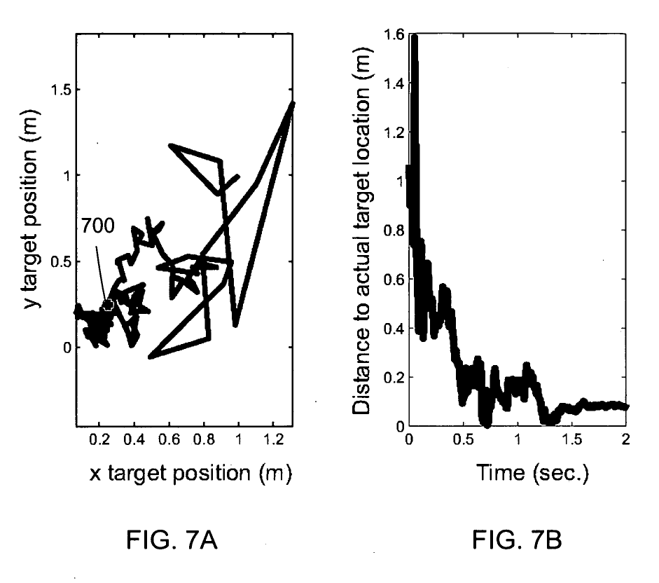

An exemplary decoding performance for the target estimation trial is illustrated in FIGS. 7A and 7B. The true target location 700 in FIG. 7A can be located at (0.25 m, 0.25 m). In these figures, the estimate of the target location is shown to settle close to the true target location relative to the initial target estimate within approximately 1.5 seconds of a 2 second reach.

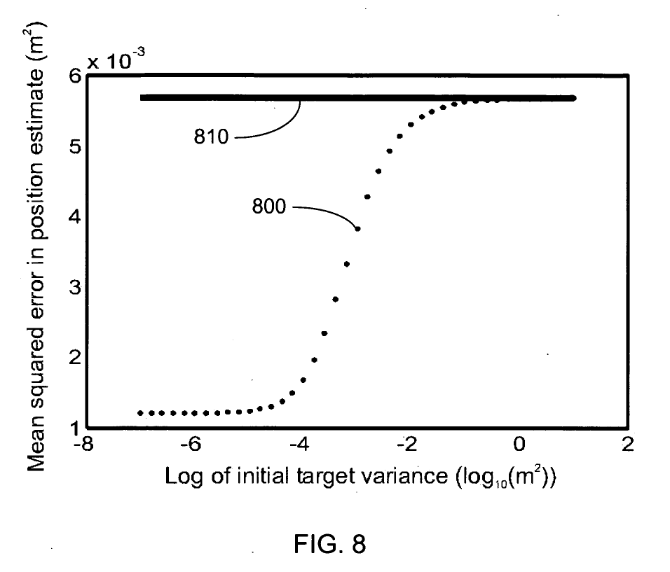

Further, the mean squared errors for trajectory reconstruction may be examined as the target state became more uncertain. One common simulated set of neural data may be used to make a performance comparison between the two methods. Mean squared errors may be averaged over 10 trials for the point process filter using the free and reach state equations separately. The exemplary results are shown in FIG. 8 over a range from 1e-7 m² to 10 m², evenly spaced by 0.2 units on a log₁₀(m²) scale. The mean squared error line for the reach state equation 800 can approach that of the free movement state equation 810 as Π_{T} grows large, and also flattens as Π_{T} approaches zero. These simulation results likely confirm that the mean squared error of the reconstruction using the reach state equation approaches that of the free movement state equation as the uncertainty in the target position grows.

The individual performance of the exemplary models may be specific to the set of neuron tuning curves that is selected. Additionally, the relative improvement observed in FIGS. 2A-2C, 3A-3C, 4A-4C and 5A-5C using the reach model over the free model may also be particular to the quality and quantity of any particular ensemble of neurons. For example, if the ensemble is perfectly informative about the trajectory, no additional benefit may be gained from neural-derived observations on the target state.

For example, FIGS. 2A-2C and 3A-3C illustrate an exemplary reach model initially used to generate the reach trajectories. Point process filtering reconstructions using a free movement state equation 205 and a reach movement state equation 207 were compared against true movement values 200. Position and velocity reconstructions (FIGS. 2A-2C and 3A-3C. respectively) are provided for one trial with an almost perfectly known target (e.g., initial target position and velocity variances of 0.001 a.u.²). With reference to FIGS. 4A-4C and 5A-5C, the exemplary model used to generate the reach trajectories may have an appropriately scaled cosine velocity profile. Again, the exemplary results can be compared for point process filtering using free movement state equations 405 and reach movement state equations 407 against true values 400 in FIG. 4A. Target position and velocity variance may be almost perfectly known to the filter (e.g., initial target position and velocity variances of 0.001 a.u.²).

The results from other examples of the reconstructions are shown in FIGS. 7A and 7B for an almost perfect knowledge of target, where the target location estimates are refined during the reach.

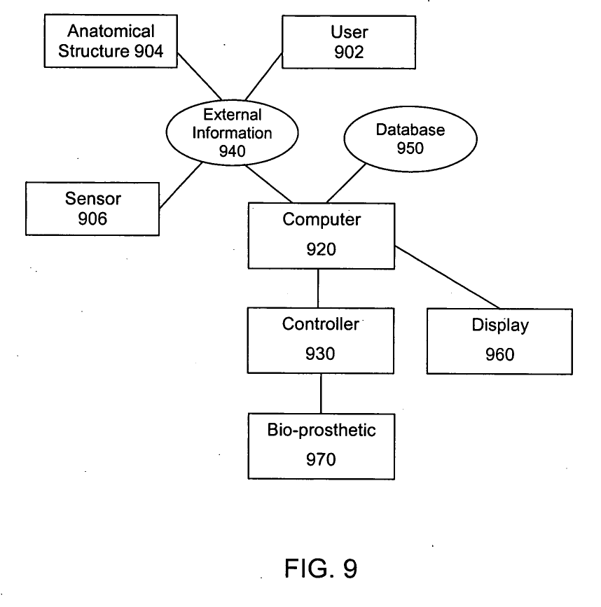

An exemplary embodiment of a system for implementing the present invention is shown in FIG. 9. For example, a database 950 may contain characteristics relating to possible configurations of bio-prosthetic 970. The database 950 may also contain additional information, such as the response dynamics of the bio-prosthetic to signals from a controller 930, torque, force and/or velocity operating ranges for the bio-prosthetic, and the like. The system may further comprise and/or utilize external information 940, which may optionally vary with time. The external information 940 can include, e.g., a precise or estimated location of the desired target, the time to reach the target, or particular intermediate configurations of the bio-prosthetic during the execution of the trajectory, including position and/or velocity. This external information 940 may be provided directly by a user 902. It may also be provided by signals generated from an anatomical structure 904, which may optionally be associated with the user 902. The anatomical structure 904 can be an eye, an ear, a brain or region therein, a bodily appendage, or any other organ that is capable of sensory detection such as sight, sound, or touch, which is capable of providing signals in response to such sensory detection. The external information 940 may also be provided by the signals generated by a sensor 906, which can be any type of sensor including, but not limited to, optical or mechanical sensors. The sensor 906 may also be coupled directly or indirectly to a bio-prosthetic 970.

The external information 940 and information contained in the database 950 can be communicated to computer 920. The computer 920 may be configured to calculate state information for the bio-prosthetic 970 based at least in part on these informations in accordance with the exemplary embodiment of the methods of the present invention described above. State information determined by computer 920 may be communicated to a display 960. The display 960 may comprise any suitable display device, including but not limited to a video monitor, a printer, a data storage medium, a sound generator, and the like. The computer 920 may also communicate state information to a controller 930, which can be in communication with, or optionally incorporated into, the bio-prosthetic 970. The controller 930 can be capable of providing signals to the bio-prosthetic 970 to at least partially direct movement of the bio-prosthetic 970 based on the state information provided. The computer 920 can include a hard drive, CD ROM, RAM, and/or other storage devices or media which can include thereon software, which can be configured to execute the exemplary embodiments of the method of the present invention.

V. Conclusion

The exemplary reach state equation, and the exemplary system and method which can use such equations, can represent the Bayesian-optimal extension of the general autoregressive state equation that has been popular in the decoding of the free arm movements with Kalman and point process filters. The resulting exemplary model may provide a minimum constraint placed on a free arm movement based on observation of its target state.

The exemplary model may be a prior on the reach states, and can be used in conjunction with the estimation procedures that employ any modality, such as local field potentials or spikes, or any formulation between the measured signals and desired reaching movement. The result can be extended to accommodate uncertain reach duration.

One preferable exemplary feature of the model of the method and system of the exemplary embodiment of the present invention is that by switching between the informative and uninformative target estimates, the reconstruction can alternate between reaching and free arm movements. For neural prosthetics, preserving the dynamics of the exemplary system between reaching and free movement modes may be easier for the user than switching to an entirely different set of priors between these two movement modes.

Because the reach state equation can place small constraints on the motion, it is likely to be more robust to model violations than trajectory models derived from optimization of specialized cost functions as described in E. Todorov, “Optimality principles in sensorimotor control”, Nature Neurosci., vol. 7, no. 9, pp. 907-915, Sept. 2004, or models based on empirical databases described in C. Kemere et al., Model-Based Decoding of Reaching Movements for Prosthetic Systems“, Proc. 26th Annu. Int. Conf IEEE EMBS, San Francisco, Calif., pp.4524-4528, Sept. 1-5, 2004.. This benefit may be important in providing the user both flexibility and control. The method and device according to the exemplary embodiment of the present invention may also provide a closed form solution and may be more efficient and easy to implement than conventional methods requiring numerical optimization.

The exemplary reach state equation may be a basic example of a closed loop stochastic control model in that the forcing term is determined by the current and end states rather than a preformed control sequence. Other exemplary approaches in accordance with the present invention may examine the use of Monte Carlo methods with nonlinear system dynamics or stochastic optimal control with relatively unconstrained cost functions such as minimum target variance.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. In addition, all publications referenced above are incorporated herein by reference in their entireties.

What is claimed is:

1. A method for providing state information which relates to at least one of a simulated execution or an actual execution of at least one trajectory of an object, comprising:
(a) obtaining a first data set associated with signals from at least one anatomical structure corresponding to a first aspect of at least one trajectory of the object, wherein the first data set comprises first information for at least a portion of the trajectory of the object, wherein the first information is obtained prior to the execution of the at least one trajectory;
(b) obtaining a second data set associated with signals from the at least one structure corresponding to a second aspect bf the at least one trajectory of the object, wherein the second data set comprises second information for at least a portion of the at least one trajectory of the object, wherein the second information is obtained during the execution of the at least one trajectory; and
(c) generating the state information by associating the first and second data sets, wherein the state information is generated independently of data associated with predetermined trajectories.

2. The method according to claim 1, wherein the structure is a brain of a mammal.

3. The method according to claim 1, wherein the structure is an eye of a mammal.

4. The method according to claim 1, wherein the structure is a tongue of a mammal.

5. The method according to claim 1, wherein the structure is a muscle of a mammal.

6. The method according to claim 1, wherein step (c) further comprises associating a third data set associated with a minimal probabilistic constraint on the at least one trajectory and a current position of the object.

7. The method according to claim 1, wherein the first data set further comprises information obtained by estimating a particular state of the at least one trajectory at a later point in time.

8. The method according to claim 1, wherein step (b) is performed in a recursive manner.

9. The method according to claim 1, wherein step (c) is performed in real time.

10. The method according to claim 1, wherein the second information comprises a time at which the object reaches at least one particular state of the at least one trajectory.

11. The method according to claim 10, wherein the time is estimated in real time and in a recursive manner.

12. The method according to claim 1, wherein at least one of the first information or the second information excludes a predetermined arrival time for a particular state.

13. The method according to claim 1, wherein the at least one trajectory comprises a plurality of trajectories.

14. The method according to claim 1, wherein the at least one anatomical structure comprises a plurality of anatomical structures.

15. The method according to claim 1, further comprising using the state information to affect the execution of the at least one trajectory of the object.

16. A system for providing state information which relates to a simulated or actual execution of at least one trajectory of an object, comprising:
a storage arrangement which provides thereon a set of instructions, which when executed by a processing arrangement, are configured to:
a. obtain a first data set associated with signals from at least one anatomical structure corresponding to a first aspect of at least one trajectory of the object, wherein the first data set comprises first information for at least a portion of the trajectory of the object, and wherein the first information is obtained prior to the execution of the at least one trajectory,
b. obtain a second data set associated with signals from the at least one structure corresponding to a second aspect of the at least one trajectory of the object, wherein the second data set includes second information for at least a portion of the at least one trajectory of the object, and wherein the second information is obtained during the execution of the at least one trajectory, and
c. generate state information by associating the first and second data sets, wherein the state information is generated independently of data associated with predetermined trajectories.

17. The system of claim 15, further comprising a controller capable of receiving the state information and providing signals capable of controlling at least one aspect of the at least one trajectory of the object in response to the received state information.

18. The system of claim 17 wherein the object is a bio-prosthetic.

19. An executable arrangement for providing state information which relates to a simulated or actual execution of at least one trajectory of an object, comprising:
(a) a first set of instructions which is capable of enabling a processing arrangement to obtain a first data set associated with signals from at least one anatomical structure corresponding to a first aspect of at least one trajectory of the object, wherein the first data set includes first information for at least a portion of the trajectory of the object, and wherein the first information is obtained prior to the execution of the at least one trajectory;
(b) a second set of instructions which is capable of enabling a processing arrangement to obtain a second data set associated with signals from the at least one structure corresponding to a second aspect of the at least one trajectory of the object, wherein the second data set includes second information for at least a portion of the at least one trajectory of the object, wherein the second information is obtained during the execution of the at least one trajectory; and
(c) a third set of instructions which is capable of enabling a processing arrangement to generate state information by associating the first and second data sets, wherein the third information is generated independently of data associated with predetermined trajectories.

20. A computer-accessible medium comprising executable instructions for providing state information which relates to a simulated or actual execution of at least one trajectory of an object, wherein, when the executable instructions are executed by a processing arrangement, the executable instructions perform the steps comprising:
(a) obtaining a first data set associated with signals from at least one anatomical structure corresponding to a first aspect of at least one trajectory of the object, wherein the first data set comprises first information for at least a portion of the trajectory of the object, wherein the first information is obtained prior to the execution of the at least one trajectory;
(b) obtaining a second data set associated with signals from the at least one structure corresponding to a second aspect of the at least one trajectory of the object, wherein the second data set comprises second information for at least a portion of the at least one trajectory of the object, wherein the second information is obtained during the execution of the at least one trajectory; and
(c) generating the state information by associating the first and second data sets, wherein the state information is generated independently of data associated with predetermined trajectories.
